(19) United States
(12) Patent Application Publication
(10) Pub. No.: US 2015/0268358 A1
(43) Pub. Date: Sep. 24, 2015

(54) Radiometric Measuring Device

(71) Applicant: VEGA Grieshaber KG, Wolfach (DE)

(72) Inventors: Ralf Koernle, Zell a. H. (DE); Winfried Rauer, Fischerbach (DE); Wolfram Dreher, Zell a. H. (DE)

(21) Appl. No.: 14/553,242

(22) Filed: Nov. 25, 2014

(30) Foreign Application Priority Data
Dec. 6, 2013 (DE) 10 2013 113 633.8

(51) Int. Cl. G01T 1/208; G01F 23/288

(52) U.S. Cl. CPC G01T 1/208; G01F 23/288

(57) ABSTRACT

Radiometric measuring arrangement comprising a detecting device having a longitudinally elongated scintillator, a photomultiplier for transforming flashes of light, generated in the scintillator, into electric signals, and an electronic measuring unit for processing the electric signals with a temperature monitoring device for the scintillator, wherein the detecting device has at least one interrupting device as a part of the temperature monitoring device, and said interrupting device interrupts an electric connection when a specified threshold temperature is exceeded.

### CROSS REFERENCE TO RELATED APPLICATIONS

This patent application claims priority to German Patent Application 10 2013 113 633.8, filed on Dec. 6, 2013.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to a radiometric measuring device.

2. Background of the Invention

The prior art discloses a variety of radiometric measuring arrangements for measuring the filling level, density and limit level, where in this case the measurement is performed by arranging a radioactive source of radiation and a detecting device on opposite sides of a container that is to be monitored. The radioactive source of radiation sends gamma radiation through the container in the direction of the detecting device; and this gamma radiation is more or less absorbed on its way through the filling material as a function of the filling level and the density of the filling material. Then the filling level or the density of a filling material that is located between the source of radiation and the detecting device can be determined on the basis of the intensity of radiation detected by the detecting device. It is also possible to detect a limit level.

For example, in the course of measuring the filling level an intensity of radiation detected by the detecting device is indirectly proportional to a filling level in the container, so that a high quality measurement of the filling level is possible.

One particular advantage of the radiometric measurement of the filling level is that the components, i.e. the source of radiation and the detecting device, that are necessary for the measurement can be arranged outside a container and, as a result, neither the process conditions inside the container nor the properties of the filling material have an effect on the usability of this method of measurement.

In the case of the radiometric measuring arrangements known from the prior art it is known that the detecting device is designed as a scintillator with a photomultiplier that is connected to said scintillator. The gamma radiation, incident on the scintillator material, excites said scintillator material by means of impact processes, so that the scintillator material returns into its initial state while simultaneously emitting light. Then the intensity of the incoming radiation and, thus, as stated above, a filling level inside the container can be determined by measuring the quantity of light that ensues, for example, by way of a photomultiplier and an electronic unit that is connected to said photomultiplier. However, in particular, organic scintillator materials, for example, polymeric solids, are extremely temperature sensitive and may, therefore, not be stored or operated above a certain threshold temperature. In the case of polystyrene as the scintillator material this threshold temperature is, for example, +50 deg. C.

Therefore, it is known from the prior art to monitor the maintenance of this threshold temperature by means of so-called temperature measuring strips. If, for example, a scintillator, which is constructed in the form of a tube and which has, for example, a length of 5 meters, is used, then such temperature measuring strips are affixed on the scintillator in such a way that they are distributed over the length, for example, at intervals of 50 cm. The problem with this arrangement is that the temperature measuring strips that are used are subject to an aging process and, therefore, have to be replaced after a period of use of a maximum of 18 months. Such a requirement implies a high cost of maintenance that is perceived to be a drawback, so that the temperature measuring strips are often not replaced or at least not replaced at regular intervals.

Since the operational capability of the scintillator depends absolutely on whether said scintillator has not exceeded the threshold temperature, any malfunctions that have been caused by overshooting the temperature limit cannot be identified; and then additional inspections of the entire measuring arrangement have to be carried out. This situation is also perceived to be a drawback.

The object of the present invention is to further develop a radiometric measuring arrangement, which is known from the prior art, in such a way that the maintenance costs that are necessary in the prior art, are reduced and that the measurement reliability is increased.

This engineering object is achieved by means of a radiometric measuring arrangement having the features disclosed in patent claim 1. Advantageous further developments of this measuring arrangement are disclosed in the dependent patent claims.

### BRIEF SUMMARY OF THE INVENTION

In a preferred embodiment, a radiometric measuring arrangement comprising a detecting device with a scintillator, a photomultiplier for transforming flashes of light, generated in the scintillator, into electric signals, and an electronic measuring unit for processing the electric signals with a temperature monitoring device for the scintillator, wherein the detecting device has at least one interrupting device as a part of the temperature monitoring device, and said interrupting device interrupts an electric connection when a specified threshold temperature is exceeded.

In another preferred embodiment, the radiometric measuring arrangement as described herein, wherein the interrupting device is designed as at least one thermal fuse.

In another preferred embodiment, the radiometric measuring arrangement as described herein, wherein the interrupting device comprises at least one series circuit of at least two, preferably at least four, even more highly preferred at least ten thermal fuses.

In another preferred embodiment, the radiometric measuring arrangement as described herein, wherein the interrupting device is coupled to a transmission unit.

In another preferred embodiment, the radiometric measuring arrangement as described herein, wherein that the transmission unit is designed as an oscillating circuit.

In another preferred embodiment, the radiometric measuring arrangement as described herein, wherein the transmission unit is designed as an RFID transmission unit.

In another preferred embodiment, the radiometric measuring arrangement as described herein, wherein the interrupting device is connected to the RFID transmission device in such a way that a coil, acting as a transmitting antenna, is decoupled, when the interrupting device has tripped.

In another preferred embodiment, the radiometric measuring arrangement as described herein, wherein the interrupting device is connected to the oscillating circuit in such a way that in the event of an untripped interrupting device said oscillating circuit oscillates at a different frequency than if the interrupting device has tripped.

In another preferred embodiment, the radiometric measuring arrangement as described herein, further comprising wherein a plurality of thermal fuses are arranged so as to be distributed over the length of the scintillator.

In another preferred embodiment, the radiometric measuring arrangement as described herein, further comprising wherein at least one querying device is provided.

In another preferred embodiment, the radiometric measuring arrangement as described herein, wherein the at least one querying device is suitably designed to excite the oscillating circuit(s) to oscillate and/or to detect an oscillation of an oscillating circuit.

In another preferred embodiment, the radiometric measuring arrangement as described herein, wherein the at least one querying device excites wirelessly the oscillating circuit(s) to oscillate and/or to detect an oscillation of an oscillating circuit.

In another preferred embodiment, method of use of a plurality of thermal fuses in a radiometric measuring arrangement with a detecting device with a longitudinally elongated scintillator, a photomultiplier for transforming flashes of light, generated in the scintillator, into electric signals, and an electronic measuring unit for processing the electric signals as a component of a temperature monitoring device for the scintillator.

### BRIEF DESCRIPTION OF THE DRAWINGS

FIG. 1 is a line drawing evidencing a radiometric measuring arrangement.

FIG. 2 is a line drawing evidencing a simplified block diagram of the measuring arrangement from FIG. 1 with a temperature monitoring device.

FIG. 3 is a line drawing evidencing a portion of the temperature monitoring device from FIG. 2.

FIGS. 4a and 4b is a line drawing evidencing two examples of embodiments of a temperature monitoring device with an RFID transmission device.

FIGS. 5a and 5b is a line drawing evidencing an alternative embodiment of the temperature monitoring device from FIG. 3 with an oscillating circuit.

### DETAILED DESCRIPTION OF THE INVENTION

A radiometric measuring arrangement according to the invention has at least one detecting device with a preferably longitudinally elongated scintillator, a photomultiplier for transforming flashes of light, generated in the scintillator, into electric signals, and an electronic measuring unit for processing electric signals with a temperature monitoring device for the scintillator, where in this case the detecting device has at least one interrupting device as a part of the temperature monitoring device, and said interrupting device interrupts an electric connection when a specified threshold temperature is exceeded.

With such an arrangement it is possible to dispense with the temperature measuring strips used in the prior art; and at the same time an electronic inspection of whether the specified threshold temperature has been exceeded can be carried out. Moreover, it is also possible to satisfy the objective of dispensing with a visual inspection of the individual temperature monitoring devices (temperature measuring strips) and, as a result, achieving an automatic monitoring operation.

A particularly simple configuration of such a temperature monitor device is achieved, if the interrupting device is designed as at least one thermal fuse.

Thermal fuses are available on the open market for a wide range of threshold temperatures, so that an optimal adjustment to a threshold temperature that is applicable to the respective scintillator material can be performed.

In the present embodiment a thermal fuse is defined as a component that can be used in an electric circuit and with which a circuit, which is closed by means of a temperature sensitive material, is opened, for example, by means of a spring force when a threshold temperature is exceeded. Temperature sensitive materials that may be used include, for example, any material that has a certain melting point. One essential feature of such thermal fuses is that an interruption of the circuit is irreversible, so that in contrast to the use of bi-metal elements, when the threshold temperature is exceeded, the circuit is not closed again owing to a subsequent undershooting of the threshold temperature. Such a component may be, for example, a melting fuse.

The temperature monitoring device 10 can be mounted by gluing onto the scintillator or by heat shrinking over the scintillator with a protective tube.

A particularly simple monitoring operation can be achieved preferably for longitudinally elongated scintillators, which have, for example, a length of up to 10 meters, preferably of 3 to 6 meters, if the interrupting device is formed by a series circuit of a plurality of thermal fuses. For this purpose at least two, preferably at least four or, for example, ten thermal fuses can be connected in series and can be distributed over the length of the scintillator, so that it is even possible to detect an overshooting of the threshold temperature in certain sections. Then the detection can take place, for example, by testing the passage of the electricity conducted through the arrangement with, for example, an ohmmeter.

The interrupting device is preferably coupled to a transmission unit. With such a transmission unit that is coupled to the interrupting device it is possible to achieve the objective that a temperature monitoring operation can take place at different positions of the scintillator, if desired, even without a series circuit of various elements. In this case the transmission unit can be designed preferably wireless, so that there is no need for additional signal lines inside or along the scintillator.

In one embodiment the transmission unit is designed as an oscillating circuit. Such an oscillating circuit may be excited to oscillate by cable or without a cable, where in this case the interrupting device is connected up preferably to the oscillating circuit in such a way that the oscillating circuit has, as a function of whether the interrupting device has tripped or not, a different resonant frequency that can be detected and further processed.

In an additional embodiment the transmission unit is designed as an RFID [radio frequency identification] transmission device, where in this case the interrupting device is connected preferably to the RFID transmission device in such a way that a transmitting antenna, preferably a coil acting as a transmitting antenna, is decoupled or short-circuited from the RFID transmission device, when the interrupting device has tripped.

In a further development the interrupting device can be connected to the oscillating circuit in such a way that in the event of an untripped interrupting device said oscillating circuit oscillates at a different frequency than if the interrupting device has tripped. Such a change in the resonant frequency of the oscillating circuit can be achieved, for example, if a coil of the oscillating circuit, which acts as an inductance, is partially bridged when the interrupting device is not tripped; and when the interrupting device is tripped, the effective value of said resonant frequency is changed.

An additional possibility for changing the resonant frequency of an oscillating circuit consists of constructing the oscillating circuit, for example, with a parallel circuit comprising a first capacitor and a second capacitor, where in this case the second capacitor is separated from the parallel circuit when the interrupting device is tripped; and in this way the capacitance acting in the oscillating circuit and, as a result, the resonant frequency of said oscillating circuit is also changed.

Preferably a plurality of thermal fuses can be arranged so as to be distributed over the length of the scintillator, so that a local overshooting of the threshold temperature can also be detected.

In this respect the individual thermal fuses can be connected either individually or, as stated above, connected in series to a transmission unit or the transmission unit. The use of a plurality of separate transmission units has the advantage that the point, at which the scintillator has locally exceeded the threshold temperature, can be clearly identified in this way; and, in addition, there is no need for corresponding signal lines for connecting up the interruption devices.

In addition, the temperature monitoring device has preferably a querying device. In this case the querying device can be designed, for example, for querying an RFID transmission unit or for exciting an oscillating circuit and for detecting a dying out of the oscillating circuit. Correspondingly the querying device is designed preferably wireless, so that it excites the oscillating circuit(s) to oscillate by emitting an electromagnetic signal at a certain frequency and then detects preferably a resulting oscillation of the oscillating circuit or more specifically the frequency of said oscillating circuit.

In addition, the invention relates to the use of a plurality of thermal fuses in a radiometric measuring arrangement with a detecting device having a longitudinally elongated scintillator, a photomultiplier for transforming flashes of light, generated in the scintillator, into electric signals, and an electronic measuring unit for processing the electric signals as a component of a temperature monitoring device for the scintillator. To date such a use of thermal fuses has not been known from the prior art and also exhibits the advantages described above in conjunction with the measuring arrangement.

### DETAILED DESCRIPTION OF THE FIGURES

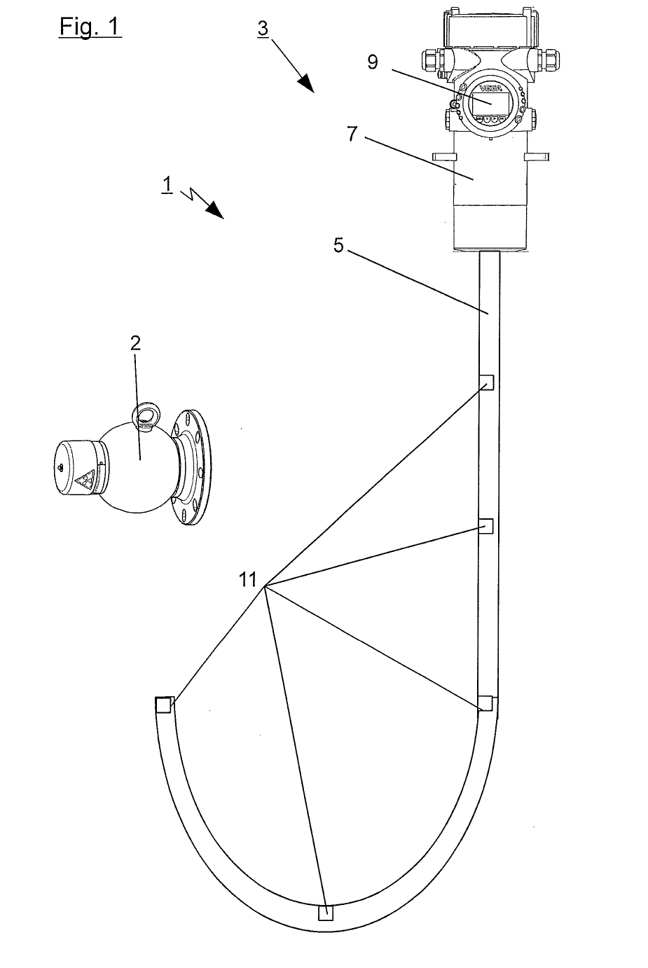

FIG. 1 shows a radiometric measuring arrangement 1 according to the present application. The measuring arrangement 1 is constructed in essence from a source of radiation 2 and a detecting device 3, where in this case a container, which is arranged between the source of radiation 2 and the detecting device 3 and which has filling material or more specifically the material to be measured, is not depicted in FIG. 1. In the present embodiment that is shown for illustrative purposes, the detecting device 3 is constructed from a longitudinally elongated scintillator 5 and, connected to said scintillator, a photomultiplier 7 and an electronic measuring unit 9. The photomultiplier 7 and the electronic measuring unit 9 are known in terms of their construction and their design from the prior art, so that there is no need to delve into the details at this point.

In the present embodiment that is shown for illustrative purposes, the longitudinally elongated scintillator 5 is made of a scintillator material, in the present embodiment polystyrene, and is provided with a light-proof coating. In FIG. 1 there are five interrupting devices 11, which are arranged over the length of the scintillator 5 as a component of a temperature monitoring device 10, which will be explained below. Such a distribution of the interrupting devices 11 makes it possible to monitor a threshold temperature δ in the individual sections of the scintillator 5, so that even a local overshooting of the threshold temperature δ can be detected.

As an alternative to the embodiment shown in FIG. 1, it is also possible to transmit the information about the state of the interrupting device 11 even over the bus 60 and to evaluate in the control station.

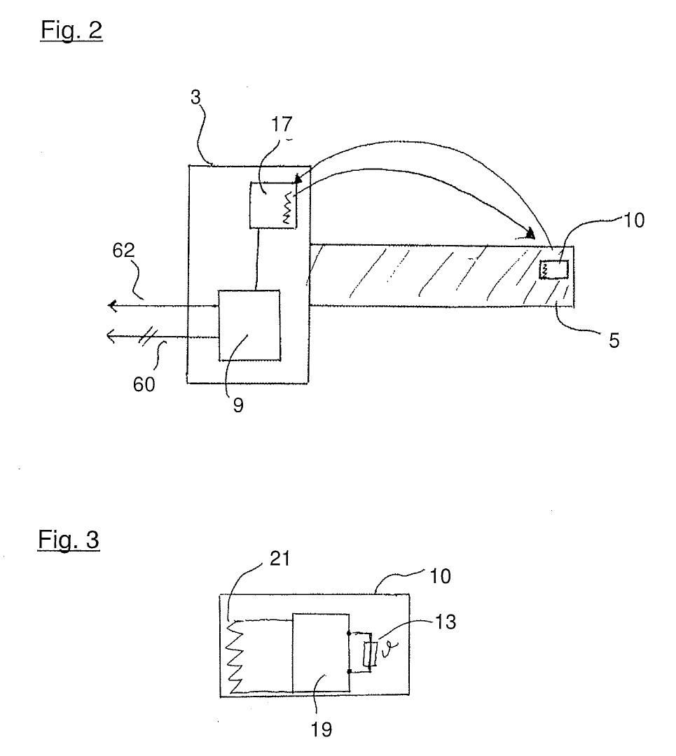

FIG. 2 shows a simplified block diagram of the detecting device 3 from FIG. 1. In the present embodiment that is shown for illustrative purposes, the temperature monitoring device 10 is shown only in schematic form and is disposed on the scintillator 5. Said temperature monitoring device communicates in a wireless manner with a querying device 17, which is connected to an electronic measuring unit 9 in the detecting device 3. The electronic measuring unit 9 in turn is connected via a bus 60 to a measuring stand in order to display and monitor the measured values that were determined from the radiometric measuring device 1. In addition to the bus 60, there is also a signal line 62, with which warning signals or error signals can be transmitted to the measuring station or a separate indicating device.

As a general principle, it is also possible to operate the radiometric measuring device 1 comprising the source of radiation 2 and the detecting device 3 independently, i.e. without attachment to a measuring station. In the case of large scale industrial applications such an attachment ought to be expedient as a rule, for example, for combining the measured values of a wide range of measuring arrangements.

In FIG. 3 the temperature monitoring device 10 from FIG. 2 is shown in more detail.

In the present embodiment that is shown for illustrative purposes, the temperature monitoring device 10 is connected to an RFID transmission unit 19 and to an antenna 21 that is coupled to the RFID transmission unit. The arrangement in FIG. 3 is configured in such a way that a tripping of the thermal fuse 13 detected by the RFID transmission unit 19 is detected, in particular, during an active querying by means of the querying device 17 and a status of the thermal fuse 13 is fed back to the querying device 17 from the RFID transmission unit 19. In this way the status of the thermal fuse 13 can be queried wirelessly; and an overshooting of the threshold temperature δ can be detected.

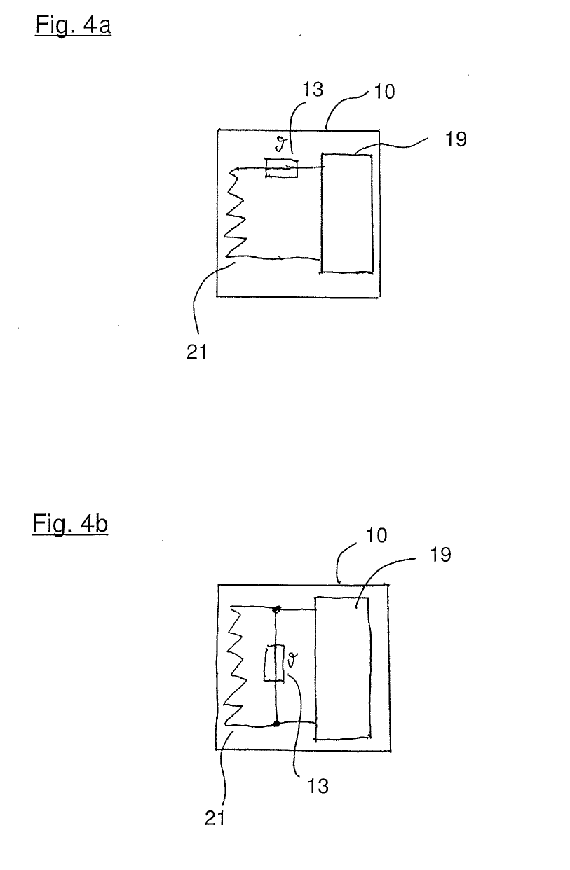

FIGS. 4a and 4b show two concrete alternatives for connecting up the temperature monitoring device 10 from FIG. 3. FIG. 4a shows an interconnection, where the antenna 21 is connected in series to the thermal fuse 13 and is connected to the RFID transmission unit 19. After tripping the thermal fuse 13, the antenna 21 is electrically isolated from the RFID transmission unit 19, so that any attempt on the part of the querying device 17 to query will be unsuccessful.

FIG. 4b shows an alternative interconnection, where in this case the antenna 21 and the thermal fuse 13 are connected in parallel and are connected to the RFID transmission unit 19. Hence, in the untripped state of the thermal fuse 13 the antenna 21 is short circuited, so that a querying attempt on the part of the querying device 17 will be unsuccessful. As soon as the thermal fuse 13 has tripped on the basis of an overshooting of the threshold temperature δ and, in so doing, the electric connection inside the thermal fuse 13 is interrupted, the antenna 21 is no longer short circuited or bridged, and a querying attempt on the part of the querying device 17 will lead to feedback from the RFID transmission unit 19.

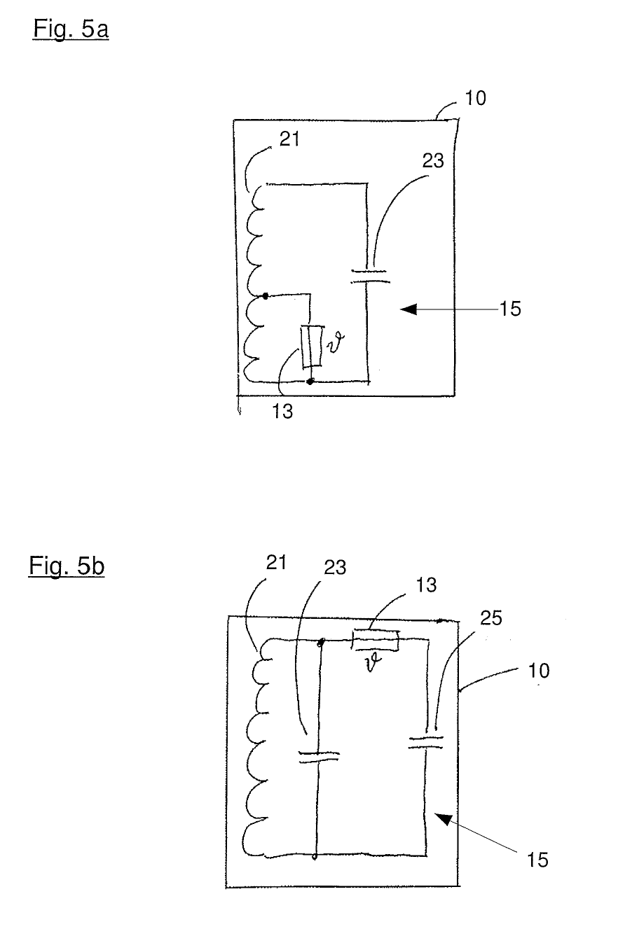

FIGS. 5a and 5b show embodiments for a temperature monitoring device 10, where in this case the temperature monitoring device 10 is implemented by means of an oscillating circuit 15.

The oscillating circuit, shown in FIG. 5a, is constructed in the conventional way with a coil 21 that is designed as an antenna to form a first capacitor 23. In the present embodiment that is shown for illustrative purposes, the thermal fuse 13 is connected in parallel to a part of the coil 21, so that the inductance of the coil 21 changes as a function of a tripping state of the coil 13. In the specific case a part of the coil 21 is short circuited when the thermal fuse 13 is not tripped, so that the inductance of the coil 21 is reduced. As soon as the threshold temperature δ is exceeded and, in so doing, the thermal fuse 13 trips, the short circuited part of the coil 21 also acts as an inductance, so that the resonant frequency of the oscillating circuit 15 is decreased in accordance with the change in the inductance.

FIG. 5b shows an alternative embodiment, where the oscillating circuit 15 is constructed from the coil 21 and a parallel circuit composed of the first capacitor 23 with a series circuit composed of the thermal fuse 13 and a second capacitor 25. Hence, in the untripped state of the thermal fuse 13, the first capacitor 23 and the second capacitor 25 are connected in parallel, so that their capacitances add up. In the untripped state of the thermal fuse 13 the oscillating circuit 15 will oscillate at a characteristic resonant frequency when excited by means of the querying device 17. As soon as the threshold temperature δ of the thermal fuse 13 has been exceeded the first time, this thermal fuse trips; and the parallel circuit comprising the first capacitor 23 and the second capacitor 25 is cleared, so that only the first capacitor 23 continues to act in the oscillating circuit 15 as a capacitance. When the oscillating circuit is excited, it dies out correspondingly at a higher resonant frequency, a state that in turn can be detected by means of the querying device 17.

In the exemplary embodiment according to FIGS. 5a and 5b, the querying device 17 can be designed, for example, as a transmitter for emitting an excitation signal that is preferably in the form of a pulse. In this case, after the excitation signal has been emitted, the passive circuits at the scintillator 5 die out at a characteristic frequency that is a function of the state of the thermal fuse 13. The querying unit can determine the state of the thermal fuse 13 by determining this decay frequency.

At this point it should be pointed out that in the above described embodiments that are presented only for illustrative purposes, the thermal fuse 13 may also be formed by means of a series circuit comprising a plurality of thermal fuses. The above described operating principle of the individual interconnection variants does not change as a result.

An inspection of the temperature monitoring device 10 can be initiated by hand and, in so doing, can take place once or can be activated periodically, where in this case the respective state of the interrupting device is determined with each query, and optionally a warning message is emitted.

### LIST OF REFERENCE NUMBERS

1 radiometric measuring arrangement
2 source of radiation
3 detecting device
5 scintillator
7 photomultiplier
9 electronic measuring unit
10 temperature monitor devices
11 interrupting device
13 thermal fuse
14 transmission unit
15 oscillating circuit
17 querying device
19 RFID chip/transmission unit
21 antenna/coil
23 first capacitor
25 second capacitor
60 bus
62 signal line
δ threshold temperature

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. A radiometric measuring arrangement comprising a detecting device with a scintillator, a photomultiplier for transforming flashes of light, generated in the scintillator, into electric signals, and an electronic measuring unit for processing the electric signals with a temperature monitoring device for the scintillator, wherein the detecting device has at least one interrupting device as a part of the temperature monitoring device, and said interrupting device interrupts an electric connection when a specified threshold temperature is exceeded.

2. The radiometric measuring arrangement of claim 1, wherein the interrupting device is designed as at least one thermal fuse.

3. The radiometric measuring arrangement of claim 1, wherein the interrupting device comprises at least one series circuit of at least two, preferably at least four, even more highly preferred at least ten thermal fuses.

4. The radiometric measuring arrangement of claim 1, wherein the interrupting device is coupled to a transmission unit.

5. The radiometric measuring arrangement of claim 1, wherein the transmission unit is designed as an oscillating circuit.

6. The radiometric measuring arrangement of claim 1, wherein the transmission unit is designed as an RFID transmission unit.

7. The radiometric measuring arrangement of claim 5, wherein the interrupting device is connected to the RFID transmission device in such a way that a coil, acting as a transmitting antenna, is decoupled, when the interrupting device has tripped.

8. The radiometric measuring arrangement of claim 5, wherein the interrupting device is connected to the oscillating circuit in such a way that in the event of an untripped interrupting device said oscillating circuit oscillates at a different frequency than if the interrupting device has tripped.

9. The radiometric measuring arrangement of claim 2, further comprising wherein a plurality of thermal fuses are arranged so as to be distributed over the length of the scintillator.

10. The radiometric measuring arrangement of claim 9, further comprising wherein at least one querying device is provided.

11. The radiometric measuring arrangement of claim 10, wherein the at least one querying device is suitably designed to excite the oscillating circuit(s) to oscillate and/or to detect an oscillation of an oscillating circuit.

12. The radiometric measuring arrangement of claim 10, wherein the at least one querying device excites wirelessly the oscillating circuit(s) to oscillate and/or to detect an oscillation of an oscillating circuit.

13. A method of use of a plurality of thermal fuses in a radiometric measuring arrangement with a detecting device with a longitudinally elongated scintillator, a photomultiplier for transforming flashes of light, generated in the scintillator, into electric signals, and an electronic measuring unit for processing the electric signals as a component of a temperature monitoring device for the scintillator.
